(19) United States
(12) Patent Application Publication
(10) Pub. No.: US 2026/0079769 A1
(43) Pub. Date: Mar. 19, 2026

(54) Interactive software launch bot

(71) Applicant: Hewlett Packard Enterprise Development LP, Spring, TX (US)

(72) Inventors: Ju-Chun Lou, Taoyuan City (TW); Hsing Wei Yu, New Taipei City (TW); Hao Chang, Taipei City (TW)

(21) Appl. No.: 18/887,858

(22) Filed: Sep. 17, 2024

(51) Int. Cl. G06F 9/52; G06F 9/50; G06F 11/36

(52) U.S. Cl. CPC G06F 9/52; G06F 9/5027; G06F 9/5083; G06F 11/3688

(57) ABSTRACT

According to an implementation, a computer system and method for interactive software launching and testing is proposed, which features a mechanism for injecting monitoring capabilities into software tools or test executables, enabling continuous collection and analysis of environmental data. The system can record and organize observed data and execution results, maintaining a real-time inference database for rapid lookup and decision-making. The database can be dynamically updated to refine predictive capabilities and leveraged to coordinate simultaneous execution across multiple servers and environments. The system can provide real-time execution adjustments, error detection, and optimize resource utilization. Data management techniques can be employed, such as pruning, hierarchical structuring, and confidence scoring.

### BACKGROUND

Software testing and execution in complex hardware environments, particularly those involving firmware and Basic Input/Output System (BIOS) interactions, can encounter challenges related to timing and synchronization. A recurring issue can be execution errors due to missed timing windows when, for example, changes are made to firmware components such as Read-Only Memory (ROM), Advanced Power Management Link (APML), or Complex Programmable Logic Device (CPLD). Modifications can result in cold boots or extended initialization periods, leading to unpredictable variations in boot times. Additionally, environmental factors can cause failures in specific tests like APML, necessitating complete re-runs and highlighting the value of executing certain operations within precise time slots. For example, some sensors are activated before the BIOS Power-On Self-Test (POST), while others function after it, creating an intricate sequence of timed events.

Existing approaches to managing these timing issues often rely on timeout settings within state machines. However, this approach presents challenges as it involves extensive trial and error to determine appropriate wait times, potentially leading to inefficient use of resources. The situation can become further complicated as hardware changes can significantly impact boot times and software waiting periods, making static timeout values less reliable. Test automation can face similar obstacles, as it waits for specific events to transition between states, with waiting times that prove difficult to predict accurately. An illustrative scenario is the BIOS self-test, which occurs during the POST process, and the configuration of thermal settings like linear fan control, which is set within a specific BIOS post time slot to be effective.

### BRIEF DESCRIPTION OF THE DRAWINGS

For a more complete understanding of this disclosure, and advantages thereof, reference is now made to the following descriptions taken in conjunction with the accompanying drawings, in which:

FIG. 1 is a block diagram of an implementation system;

FIG. 2 is a flowchart of an implementation method;

FIG. 3 is a flow chart of an implementation method;

FIG. 4 is a flow chart of an implementation method;

FIG. 5 is a flowchart of an implementation method;

FIG. 6 is a flow chart of an implementation method;

FIG. 7 is a flow chart of an implementation method;

FIG. 8 is a block diagram of an example cloud-based system;

FIG. 9 is a flowchart of an implementation method;

FIG. 9 is a flowchart of an implementation method; and

FIG. 10 is a flowchart of an implementation method.

### DESCRIPTION

The following disclosure provides many different examples for implementing different features. Specific examples of components and arrangements are described below to simplify the present disclosure. These are, of course, merely examples and are not intended to be limiting.

The particular implementations are merely illustrative of specific configurations and do not limit the scope of the claimed implementations. Features from different implementations may be combined to form further examples unless noted otherwise. Various implementations are illustrated in the accompanying drawing figures, where identical components and elements are identified by the same reference number, and repetitive descriptions are omitted for brevity.

Variations or modifications described in one of the implementations may also apply to others. Further, various changes, substitutions, and alterations can be made herein without departing from the spirit and scope of this disclosure as defined by the appended claims.

While the disclosure aspects are described primarily in the context of software testing and execution in complex hardware environments involving firmware and BIOS interactions, the principles and techniques discussed are non-limiting. In particular, this disclosure may similarly apply to fields where precise timing and synchronization are factors in optimum operation, such as real-time control systems, distributed computing environments, network protocol testing, embedded systems development, and automated manufacturing processes. The adaptive and responsive approach to managing timing issues and execution states could benefit any system where operations are, for example, coordinated across multiple components with varying response times and environmental dependencies.

In implementations, a computer system and interactive software launching and testing method are proposed to address challenges in complex hardware environments, such as firmware and BIOS interactions. Aspects of the disclosure introduce an approach to managing timing and synchronization issues that often plague software testing and execution. A real-time inference database is introduced, which can continuously learn from environmental data and execution results. The adaptive database can enable the system to make rapid, informed decisions about software execution across multiple servers and test environments.

An advantageous feature is injecting monitoring and control capabilities directly into software tools or test executables, allowing for real-time tracking and manipulation of execution states within target environments. The system can continuously collect and analyze environmental data, including hardware configurations, network conditions, and system loads, providing a comprehensive view of the execution landscape.

The collected data can be recorded and organized in a result and observation memory for analysis. The information can be fed into the real-time inference database, which stores and indexes patterns from the recorded data. The database can be dynamically updated based on new observations and execution results, continuously refining its predictive and adaptive capabilities.

An advantage of the proposed approach is the ability to provide real-time execution adjustments and error detection. By leveraging rapid lookups in the inference database, the system can optimize execution based on historical patterns and current conditions. This reduces reliance on predefined timeout values and static finite state machines, often inadequate in complex, dynamic environments.

The proposed approach can facilitate the simultaneous execution of software actions and environmental observations across multiple servers and test environments. The coordination can involve synchronizing execution timings, dynamically allocating computational resources based on real-time demand, maintaining distributed event logs, implementing load balancing mechanisms, and providing inter-environment communication channels.

Further, aspects of the disclosure improve the efficiency and effectiveness of software testing and execution, particularly in cases involving complex firmware interactions, varying boot times, and timing-sensitive operations. It offers a more flexible and adaptive solution to challenges that traditional timeout-based approaches struggle to address effectively.

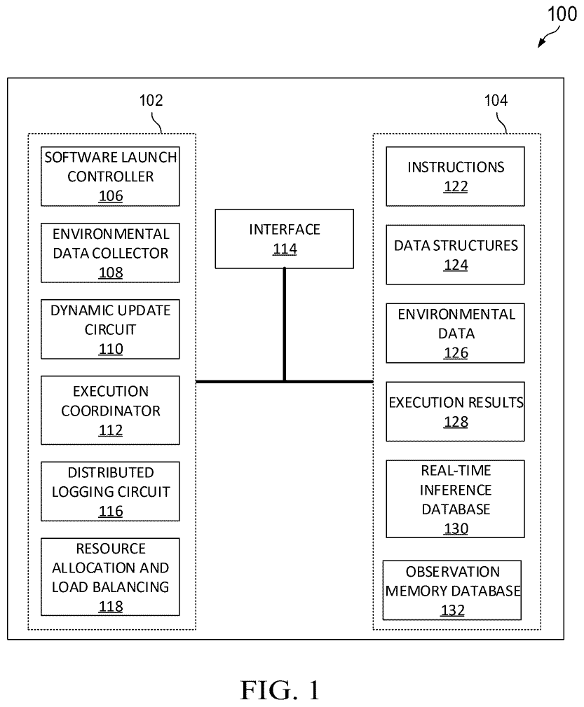

FIG. 1 illustrates a block diagram of an implementation system 100, which may be a test execution system for interactive software launching and testing. In implementations, system 100 may be coupled to one or more target servers being investigated for network configuration, storage, bios, errors, updates, or the like As shown, system 100 includes a processor 102, a memory 104, and an interface 114, which may (or may not) be arranged as shown. Although one of each component is shown in FIG. 1, the quantity is not limiting, and greater numbers are similarly contemplated in other implementations. System 100 may include additional components not depicted, such as long-term storage (e.g., non-volatile memory, etc.), power management circuitry, security and encryption modules (e.g., trusted platform modules (TPM), etc.), or the like.

Processor 102 may be any component or collection of components adapted to perform computations or other processing-related tasks. In implementations, processor 102 is a host processor, an application processor, a baseband processor, or a microcontroller. In implementations, processor 102 is configured to execute instructions stored in non-transitory memory, which can also house the data structures used by the system.

The processor 102 may incorporate several components, including a software launch controller 106, an environmental data collector circuit 108, a dynamic update circuit 110, an execution coordinator 112, a distributed event logger circuit 116, and a resource allocation and load balancing circuit 118. However, these components are not necessarily integrated within the processor 102. Depending on the implementation, they may exist as standalone circuits, processors, or controllers, be combined into a single unit, or be arranged in various combinations. The modular description is primarily for ease of explanation and does not limit the actual system architecture. Different implementations may adopt various configurations based on specific requirements.

In implementations, software launch controller 106 injects monitoring and control capabilities into software tools or test executables. This can enable real-time tracking and manipulation of execution states within the target environment.

In implementations, environmental data collector circuit 108, in conjunction with the software launch controller 106, continuously gathers and analyzes data about the execution environment, including hardware configurations, network conditions, and system loads. In an implementation, environmental data collector circuit 108 is embedded within software launch controller 106.

In implementations, the dynamic update circuit 110 continuously refines the real-time inference database 130 in memory 104 based on new environmental data 126 and execution results 128 to improve the predictive and adaptive capabilities of system 100 over time.

In implementations, the execution coordinator 112 leverages the constantly updated real-time inference database 130 to manage the simultaneous execution of software actions and environmental observations across multiple servers and test environments.

The distributed event logger circuit 116 maintains a comprehensive record of all actions and observations, providing a historical context for analysis. Meanwhile, the resource allocation and load balancing circuit 118 ensures optimal utilization of system resources.

Memory 104 may be any component or collection of components adapted to store programming, instructions, or calibration settings for execution or retrieval by processor 102. In an implementation, memory 104 includes a non-transitory computer-readable medium. In implementations, memory 104 may be configured to store (i.e., record) and organize instructions 122 to be executed by processor 102, data structures 124 used by system 100, environmental data 126 and execution results 128 for analysis, a real-time inference database 130, an observation memory database 132, or a combination thereof.

Memory 104 can efficiently record and organize the data collected by the environmental data collector circuit 108 and other system components. The data stored within memory 104 can be structured to facilitate rapid access and analysis, enabling the system 100 to make informed, real-time decisions.

In an implementation, memory 104 employs a data structure that categorizes information based on type and relevance. Environmental data, such as hardware configurations, network conditions, and system loads of one or more target servers can be organized into distinct sections within the memory 104. Each section can be further divided into subsections, allowing for granular storage and retrieval of specific data points. For example, network condition data might be subdivided into latency measurements, bandwidth utilization rates, and packet loss statistics.

Memory 104 can also maintain a separate section for execution results, including information about, for example, software behavior, error occurrences, and performance metrics. The section can be structured to allow for easy correlation between specific execution events and the corresponding environmental conditions under which they occurred. The organization enables system 100 to quickly identify patterns and relationships between environmental factors and software performance.

Memory 104 can implement a time-series data structure to manage the temporal aspect of the data at the one or more target severs. Each data point can be tagged with a high-precision timestamp, allowing for accurate reconstruction of the system's state at any moment. The temporal organization can help track the evolution of environmental conditions and software behavior over time, facilitating trend analysis and predictive modeling.

Memory 104 can incorporate an indexing system that allows rapid lookup of specific data points or ranges. The indexing can be multidimensional, considering factors such as data type, timestamp, and relevance scores assigned by the system's analysis components. Advanced data structures, such as B-trees or hash tables, can be used to ensure that data retrieval operations are highly efficient, even when dealing with large volumes of information.

Memory 104 can implement a data retention policy to optimize storage utilization and maintain system performance. The policy can define how long different types of data are kept in active memory. Critical events and significant environmental changes can be flagged for long-term storage, while more routine data points may be summarized or discarded after a certain period. The approach can ensure that memory 104 remains responsive and that the most relevant information is readily accessible.

Memory 104 can incorporate a data compression mechanism to maximize storage efficiency. Frequently occurring patterns or values can be encoded using space-efficient representations, allowing system 100 to store more information without increasing memory requirements. The compression algorithm can be chosen to balance storage efficiency with rapid decompression speed, ensuring that data access remains fast even for compressed information.

Memory 104 can include a robust error-checking and data integrity system. Checksums and error-correcting codes can detect and correct any data corruption. This ensures the reliability and accuracy of the stored information, which is crucial for the system's decision-making processes.

In implementations, the real-time inference database 130 may also be called an adaptive decision matrix. Real-time inference database 130 can store and index patterns derived from the environmental data 126 and execution results 128 to facilitate rapid lookup and decision-making based on historical and current information. In an implementation, the environmental data 126 and execution results 128 feed into the real-time inference database 130.

In implementations, the real-time inference database 130 is a dynamic knowledge repository that evolves based on the system's experiences and observations. The structure of the real-time inference database 130 can be arranged to facilitate rapid pattern matching and decision-making, enabling system 100 to respond swiftly to changing conditions in the software testing environment.

Real-time inference database 130 can be organized as a multi-dimensional matrix. Each dimension can correspond to a different environmental or operational parameter, such as hardware configuration, network status, system load, or specific software states. The multi-dimensional structure allows system 100 to capture complex relationships between various factors influencing software behavior and testing outcomes.

Within the multidimensional matrix, each cell can represent a specific combination of conditions and contains associated data such as historical outcomes, success probabilities, and recommended actions. The data in each cell is not static but is continually updated based on new observations and results, allowing the real-time inference database 130 to adapt and refine the decision-making over time.

The real-time inference database 130 can employ advanced indexing techniques to facilitate rapid lookup and decision-making. For example, it can use a combination of hash-based indexing for exact matches and nearest-neighbor search algorithms to find the closest relevant data when an exact match is unavailable. The hybrid approach allows system 100 to make informed decisions even in previously unencountered scenarios by interpolating from similar known situations.

Real-time inference database 130 can incorporate a hierarchical structure, organizing data at different levels of granularity. At the highest level, it can maintain aggregate statistics and general trends. Lower levels can contain more detailed information about specific scenarios. The hierarchical organization can allow system 100 to narrow down relevant data, starting with broad patterns and drilling down to specific details.

The real-time inference database 130 can integrate machine learning algorithms to enhance its predictive capabilities. These algorithms analyze the accumulated data to identify patterns, correlations, and trends that might take time to become apparent. The insights generated by the algorithms can be used to update the decision-making logic, constantly improving the system's ability to make accurate predictions and informed choices.

Real-time inference database 130 can feature a confidence scoring system. Each decision or prediction can be associated with a confidence score, calculated based on factors such as the amount of relevant historical data, the consistency of past outcomes, and the similarity of the current scenario to previously encountered situations. The confidence scoring can help system 100 determine when to rely on the stored knowledge and when to seek additional information or take a more cautious approach.

The real-time inference database 130 can implement an intelligent pruning mechanism to manage data growth over time. The mechanism can identify and remove outdated or irrelevant information, ensuring the table remains manageable and focused on the most pertinent data. The pruning process can consider factors such as the age of the data, its historical accuracy, and relevance to current testing scenarios.

Real-time inference database 130 can be arranged with concurrency in mind, allowing multiple system components to simultaneously query and update the table without compromising data integrity or performance. This can be achieved through locking mechanisms and data versioning, ensuring the real-time inference database 130 can support high-throughput decision-making in complex, multi-threaded testing environments.

Interface 114 may be any component or collection of components that allow processor 102 to communicate with other devices/components or a user. It facilitates real-time communication and data exchange between servers and test environments. The communication capability can allow system 100 to synchronize actions, share critical information, and maintain a cohesive testing environment across distributed resources. Interface 114 may employ various network protocols and communication standards to ensure reliable and efficient data transfer, adapting to network conditions and infrastructure configurations.

In implementations, the distributed event logger circuit 116 and interface 114 maintain a comprehensive log of actions and observations across the servers and test environments.

In implementations, the resource allocation and load balancing circuit 118 dynamically allocates computational resources based on real-time demand to optimize resource utilization across system 100.

In implementations, the components of system 100 work in concert to achieve efficient and adaptive software launching and testing. In an implementation, software launch controller 106 initiates the process by injecting monitoring capabilities into software under test at a target server. As the software executes, the environmental data collector circuit 108 gathers real-time data, which is then processed and stored in memory 104. Based on the new data, the dynamic update circuit 110 continuously refines the real-time inference database 130. Concurrently, the execution coordinator 112 uses the up-to-date information in the database to make informed decisions about test execution across multiple environments.

This integrated approach allows system 100 to address several challenges in software testing and execution. By dynamically adapting to environmental conditions and leveraging historical data, system 100 reduces reliance on static timeout values and predefined state machines. The adaptability can be valuable in complex hardware environments where boot times and execution states can vary unpredictably. The system's ability to coordinate simultaneous actions across multiple environments addresses the challenge of managing timing-sensitive operations, such as during BIOS POST or firmware initialization.

Further, the real-time inference capabilities of system 100 enable it to detect and respond to execution errors quickly, often preempting failures before they occur. The proactive approach significantly reduces the time-consuming test re-runs, addressing a common inefficiency in traditional testing methodologies. System 100 also minimizes the trial-and-error process typically associated with determining appropriate timeout values and test parameters by providing real-time suggestions and adjustments.

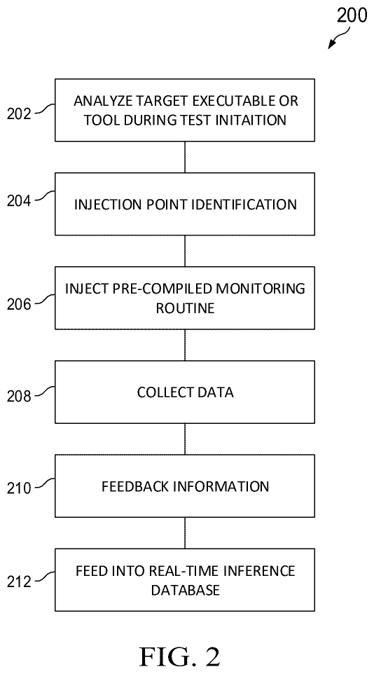

FIG. 2 illustrates a flowchart of an implementation method 200, which may be implemented by software launch controller 106. It is noted that all steps outlined in the flow chart of method 200 are not necessarily required and can be optional. Further, changes to the arrangement of the steps, removal of one or more steps and path connections, and addition of steps and path connections are similarly contemplated.

In an implementation, software launch controller 106 injects monitoring and control capabilities into software tools or test executables. The injection process can modify the target software at runtime without altering its source code. Software launch controller 106 can employ techniques such as dynamic library injection, code instrumentation, or API hooking to integrate its monitoring capabilities into the software under test seamlessly.

For example, the general problem can be stated as:
Execution: (Server A)={Tool1(State {B}), Tool 2(State {C})}, where “Server A” is the target server on which a user desires to, for example, process software, perform automation testing, or execute procedures. The “State” represents the target server status. For example, “State B” can indicate the target server is powered on and “State C” can represent the BIOS before the POST. In this example execution scenario, “Tool1” can be operating system deployment and can be set to run when the target server is in “State B” (i.e., powered on). Subsequently, “Tool2,” which can be APML testing, can be scheduled to execute when the target server transitions to “State C” (i.e., BIOS before the POST).

For example, {State A}=[Tool A(Reset)→Tool B(Mount)→Tool C(Execute Low Latency)], where “State A” represents the initial state of the target server, which can be dynamically influenced and changed as “Tool A,” “Tool B,” and “Tool C” are executed sequentially. “Tool A” performs a BIOS reset, “Tool B” mounts virtual media, and “Tool C”executes a low latency configuration in BIOS and stress testing.

A challenge can lie in the unpredictable nature of the target server's state after each tool execution, such as following the BIOS reset. The reboot procedure initiated by the reset can vary, making it at times difficult to predetermine a fixed waiting time before executing “Tool B. ” For instance, while a 100-second sleep might suffice in some cases, changes in components could necessitate a 10-minute wait, as the reboot process might repeat 2 to 4 times, potentially leaving the server stuck in BIOS.
{State B}=[Tool A(Sleep, Reset)→Tool B(Provisioning)→Tool C(Execute SPP)], where {State B} represents the various potential states of the target server as it progresses through the execution of multiple tools and procedures, starting from its current “State B. ” In this example, “Tool A” is a bundle that first initiates a sleep command to allow the server to cool down, followed by a reset operation. “Tool B” then performs OS provisioning, preparing the server for the final step. Lastly, “Tool C” executes the Service Pack for ProLiant (SPP) installation.

The sequence illustrates how the target server's state can evolve through multiple transitions, each tool potentially altering the server's condition in ways that may impact subsequent operations. Using a dictionary structure ({}) for “State B” emphasizes the dynamic and variable nature of the target server's state throughout this process, acknowledging that the exact state at any given point may depend on the outcomes of previous tool executions and the target server's responses to these operations.
TaaS={Server (1-N)}→{States}→{Tools}{Action}→{Result}, where TaaS represents the Test as a Service model managing multiple target servers (1 to N) in a shared lab environment. The {Server (1-N)} component denotes the variable number of target servers, each potentially in different states, as indicated by {States}. Based on these states, the executor determines and applies appropriate {Tools} and {Action} to perform specific tests, commands, or installations. The →{Result} signifies the outcome of these operations, which is inherently dependent on the tool execution and the target server's state.

The model acknowledges the uncertainty in precise results, represented by dictionaries {}. For instance, when User A selects to execute Tool A (APML I2C testing) on a booted server, the expected result might differ from the actual outcome. In this case, the user can experience, for example, a two-hour wait followed by a timeout, with subsequent investigation revealing the server was stuck in ROM-Based Setup Utility (RBSU). This example illustrates the complex, often unpredictable nature of interactions between servers, tools, and actions in the TaaS environment, emphasizing the advantages for adaptive and responsive testing strategies.

At step 202, software launch controller 106 analyzes the target executable or tool during test initiation. It can identify entry points, function calls, and state transitions within the software and, based on this analysis, determine the optimal locations for inserting the monitoring code.

At step 204, software launch controller 106 moves to the injection point identification stage. Here, the optimal locations within the software's structure for inserting the monitoring code can be determined. The mapping ensures that the injected code captures the most relevant and impactful data without interfering with the software's normal operation.

At step 206, software launch controller 106 injects the pre-compiled monitoring routines into the locations determined at step 204 by, for example, creating a wrapper around the original software. Depending on the specific requirements of the target software and testing environment, the integration can be achieved through techniques such as dynamic library injection, code instrumentation, or API hooking.

The software launch controller 106 can inject monitoring capabilities into each executor to enhance state control and achieve omniscience. The process, known as “State Control” in the TaaS (Testing as a Service) source code, ensures that the software launch controller 106 has comprehensive awareness of every state within the target system.

In implementations, is designed to be stateful, allowing it to maintain and track the state of each component throughout the execution process. The stateful nature can be implemented by separating and categorizing each task into individual groups. The categorization, part of the functionality of the software launch controller 106 in the TaaS source code, enables more granular control and monitoring of the target system's various components.

Once the code is injected, software launch controller 106 initiates the execution of the modified software in the target environment. This marks the beginning of the active monitoring phase, where the injected code starts intercepting and logging function calls and state transitions to create a detailed timeline of the software's execution. Concurrently, it monitors system resources and environmental parameters relevant to the software's operation, building a comprehensive picture of the execution context. This may include, for example, tracking memory usage, CPU utilization, network activity, or specific hardware interactions.

At step 208, as the software runs, software launch controller 106 engages in continuous data collection. The injected code at the target server can maintain an active communication channel with the system 100. Through the channel, the software launch controller 106 can receive real-time updates about the software's state and execution progress. The continuous flow of information allows system 100 to maintain an up-to-date awareness of the software's state across multiple test environments.

The state awareness facilitated by the software launch controller 106 allows for the system's adaptive capabilities. System 100 can make informed decisions about test progression, resource allocation, and error detection by understanding the software's current state at the target system. The awareness enables the system 100 to quickly identify deviations from expected behavior, often preempting failures before they fully manifest.

At step 210, system 100 sends instructions back to software launch controller 106, which implements adaptive controls or adjusts the software execution as directed. The feedback loop allows for dynamic responses to changing conditions or unexpected behaviors. Software launch controller 106 contributes to a continuous feedback cycle throughout the process.

The state information and execution results are fed into the real-time inference database, enriching the system's knowledge base. This ongoing input plays a crucial role in the system's learning and adaptation process, enhancing its predictive capabilities and decision-making accuracy over time.

At step 212, the state information gathered by the injected code is fed into the real-time inference database 130. The continuous influx of detailed state data enriches the system's knowledge base, enhancing its predictive capabilities and allowing for more nuanced decision-making in future test scenarios. The software launch controller 106 can link the software under test and the adaptive intelligence of the system 100, enabling a level of insight and control that would be unattainable with traditional testing methodologies.

Method 200 can be implemented, for example, as the following command: Software Launch (State, Action) ={Observe(State), Action (Observe)}, where “Observe” represents an Agent-Bot that interacts with the environment and the target server to collect characteristics that influence the running “Action.” The “Observe” function provides feedback on “Actions” such as “Provisioning,” “REST,” “REBOOT,” and “APML testing.” The “Action(Observe)” component indicates that the “Action” itself is subject to observation. The “(State, Action)”evolves as the system progresses.

For example, in the first period, we might have (“Server is RESET,” “Provisioning Tool can keep running”)={Observe(Server is RESET), Provisioning (Server is RESET)}, indicating that the server is in a reset state. Still, the provisioning tool can continue its operation.

In the second period, the state might change to (“Server POWER is unknown,” “Provisioning Tool can keep running”)={Observe(Server is Reboot, Server POWER is unknown), Provisioning (Server POWER is unknown)}, reflecting a transition where the server's power state becomes uncertain during a reboot. Yet, the provisioning tool persists in its function. The dynamic representation captures the continuous interaction between the system's state, the ongoing actions, and the observational feedback loop, allowing for adaptive responses to changing conditions in the target environment.

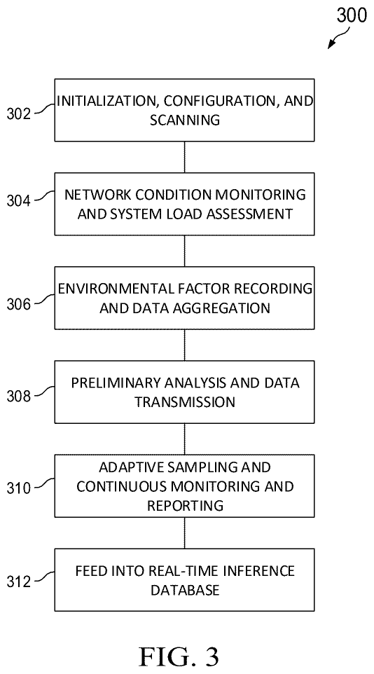

FIG. 3 illustrates a flow chart of an implementation method 300, which may be implemented by the environmental data collector circuit 108. The environmental data collector circuit 108, which can also be referred to as the Observation Engine, is configured to gather and analyze data about the execution environment.

It is noted that all steps outlined in the flow chart of method 300 are not necessarily required and can be optional. Further, changes to the arrangement of the steps, removal of one or more steps and path connections, and addition of steps and path connections are similarly contemplated.

At step 302, the environmental data collector circuit 108 sets up its monitoring systems. It adjusts parameters to align with the specific requirements of the current test scenario, ensuring that the data collection is tailored to the needs of each unique testing situation. Further, environmental data collector circuit 108 examines the current hardware setup of the target system. The examination can include gathering detailed information about the CPU type and speed, the amount and type of available memory, the characteristics of storage devices, and the presence and capabilities of various peripheral components. The hardware profile forms a baseline for understanding the system's capabilities and limitations.

The environmental data collector circuit 108 can implement observe agents to collect environmental characteristics that influence the execution results. The agents, facilitated by, for example, agent plugins, monitor various aspects of the system, including Power State, Environment monitor (OS state, Network State), Server State (FW, Model, ROM version), Time Aggregation, Server Action State, and the like.

As implemented in the TaaS (Testing as a Service) source code, this comprehensive monitoring approach ensures a holistic view of the system's state and its potential impact on test outcomes.

At step 304, the environmental data collector circuit 108 continuously observes the state of network interfaces. It can measure, for example, network performance indicators such as latency (i.e., the time taken for data to travel across the network), bandwidth utilization (i.e., how much of the available network capacity is being used), and packet loss rates (i.e., the frequency at which data packets fail to reach their destination).

The metrics provide insights into the network's health and potential impact on software performance. Moreover, environmental data collector circuit 108 monitors how intensively the system's resources are used. This can include tracking CPU usage to understand processing demand, memory consumption to gauge the sufficiency of available RAM, disk I/O rates to assess storage system performance, and process queue lengths to identify potential bottlenecks in task execution.

At step 306, when applicable, the environmental data collector circuit 108 captures data about the physical conditions in which the system operates. This could include ambient temperature and humidity levels and metrics related to power supply stability. While not always directly related to software performance, these factors can significantly impact hardware behavior and overall system reliability. The information gathered from various sources can be compiled into a structured, coherent format. This can involve synchronizing timestamps across different data points to ensure that the relationships between various events and conditions can be accurately analyzed.

At step 308, a preliminary analysis can be performed on the collected data to identify any immediate anomalies or breaches of predefined thresholds. The assessment allows for rapid response to urgent issues before system 100 conducts a more comprehensive analysis. The processed data is transmitted from the target system to the system 100 for deeper analysis and correlation with other components or systems. The transmission can be designed to be secure and efficient, employing, for example, data compression techniques to minimize network load.

The environmental data collector circuit 108 can provide feedback to enable control over actions or injection of new actions. The feedback mechanism, implemented in the TaaS source code as, for example, “suggestion” and “action injection,” allows for dynamic adjustments to the testing process based on observed environmental conditions.

For example, if the observe agents detect a significant change in the target server state or network conditions, they can suggest modifications to the current actions or inject new actions to address these changes, ensuring the testing process remains adaptive and responsive to the evolving environment.

At step 310, the environmental data collector circuit 108 dynamically adjusts the data collection frequencies. Based on observed patterns or directives from the central system, it can increase sampling rates in areas showing high variability or potential issues, ensuring that critical environmental changes are captured with appropriate detail. The environmental data collector circuit 108 can continuously monitor and analyze new data. It can maintain constant vigilance over the target system's state, providing regular updates to the system 100 and ensuring the overall testing and execution environment is thoroughly and continuously observed.

Method 300 can be implemented, for example, as the following command: Observe=Agent({Action and Historical Actions}), where “Observe” represents an Agent-Bot that interacts with the environment and the target server to collect characteristics influencing the running “Action.”

The Agent-Bot, launched alongside the “Action,” provides feedback on various operations such as “Provisioning,” “REST,” “REBOOT,” and “APML testing.” It continuously collects status information for the specific action and its historical data over time, feeding it into subsequent stages or tools.

For example, in the first period, we might have (“Server is RESET,” “Provisioning Tool can keep running”)={Observe(Server is RESET), Provisioning (Server is RESET)}.

As time progresses to the second period, the state evolves: (“Server POWER is unknown,” “Provisioning Tool can keep running”)={Observe(Server is Reboot, Server POWER is unknown), Provisioning (Server POWER is unknown)}.

By the third period, a new state is detected: (“Server stuck on RBSU,” “Provisioning Tool, New Action: Stop and Check the Boot Menu”)={Observe(Server is Reboot, Server POWER is unknown, Server stuck on RBSU), Provisioning (Server stuck on RBSU)}. Here, the “Observe Agent” detects the stuck server and feeds back a new action to stop and check the boot menu.

This complete cycle of “Tool A” becomes historical data, serving as input for the next tool. Thus, the “Observe” function for “Tool B” incorporates bot the current action and the accumulated historical actions: “Observe=Agent({Tool B and Historical Actions}).” The mechanism can ensure a continuous, adaptive process that leverages past experiences to inform current and future actions.

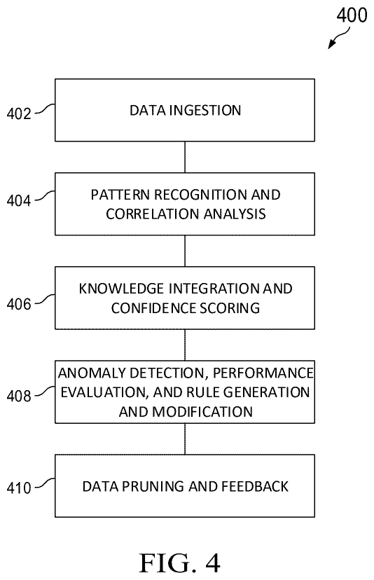

FIG. 4 illustrates a flowchart of an implementation method 400, which may be implemented in system 100 to update the real-time inference database 130. The training and learning process for the real-time inference database 130 is a continuous, dynamic operation that allows system 100 to adapt and improve its decision-making capabilities over time.

It is noted that all steps outlined in the flow chart of method 400 are not necessarily required and can be optional. Further, changes to the arrangement of the steps, removal of one or more steps and path connections, and addition of steps and path connections are similarly contemplated.

The system 100 can implement an observation memory database 132 to record the “to be trained” data. The observation memory database 132 can be structured as a hash table in memory 104, where each entry can contain various elements crucial for the learning process. The structure of the observation memory database 132, as implemented in, for example, the TaaS source code, can utilize concepts such as Hash, Characteristic, Key, and data to store and retrieve information efficiently. System 100 can employ a mechanism to memorize patterns, enhancing its ability to recognize and learn from recurring scenarios.

At step 402, system 100 continuously receives new data related to the target system from various components, including the environmental data collector circuit 108 and the software launch controller 106. The incoming data can undergo validation checks to ensure its integrity and is preprocessed to align with the database's structured format, ensuring consistency in the learning process. The preprocessed data can be stored in the observation memory database 132, ready for further analysis and training.

At step 404, system 100 employs algorithms to analyze the new data, identifying recurring patterns or trends. The newly recognized patterns can be compared against the existing knowledge in the real-time inference database 130 and the patterns stored in the observation memory database 132. The comparison can help system 100 to identify reinforcing patterns that can strengthen existing knowledge and novel patterns that may indicate new insights or changing conditions in the testing environment. The relationships between data points and system outcomes are examined to identify causal or predictive links between environmental factors and software behavior by, for example, applying statistical techniques and machine learning algorithms. This allows for understanding the complex interplay of variables that affect software performance and test outcomes. The Bayes element in the observation memory database 132 can be particularly useful in the probabilistic analysis.

At step 406, new insights are incorporated into the existing knowledge structure of the real-time inference database 130 by updating it with new information and refining its representation of the testing environment and software behavior. The integration process ensures that the database's knowledge remains current and relevant. Confidence scoring can be applied to new and existing information in the real-time inference database 130. New data can be assessed for its reliability and applicability, while the confidence scores of existing knowledge can be adjusted based on new evidence. The scoring system helps system 100 weigh the importance of different pieces of information in the decision-making process. In implementations, the observation memory database 132 is updated, ensuring that the “to be trained” data reflects the latest insights and patterns.

At step 408, data points or patterns that significantly deviate from expected norms are identified. The anomalies can be flagged for further investigation, allowing system 100 to adapt to unexpected scenarios or potential issues in the testing environment. The accuracy and effectiveness of current decision-making processes are measured. By comparing predicted outcomes with actual results, system 100 can identify areas where its predictions or actions can be improved, driving continuous enhancement of its capabilities. New decision rules are created based on the insights gained, or existing ones are modified. The rules guide the system's responses to various scenarios and their ongoing refinement to improve its adaptability and effectiveness. The new rules and insights can also be reflected in the observation memory database 132, particularly in the action and factors elements of the hash table.

At step 410, outdated or less relevant information is identified and removed, ensuring that the real-time inference database 130 remains focused on the most pertinent and recent data. The database structure can be optimized during this step to ensure efficient storage and retrieval of information. Results from actions taken based on the database's recommendations are collected. The feedback is used to refine the knowledge base of the real-time inference database 130, creating a continuous improvement cycle that allows system 100 to learn from its successes and failures, constantly enhancing its decision-making capabilities.

The refinement process can also include updating the observation memory database 132, ensuring that the “to be trained” data remains current and relevant. The date element in the memory hash table can be useful in prioritizing the more recent data and patterns.

Method 400 can be implemented, for example, as the following command: Software Launch (State, Action)={Observe(State), Action (Observe), Result, Observe(State New)→Action→Result New}, where “Observe” represents an Agent-Bot interacting with the environment and the target server to collect characteristics influencing the running “Action.”

The Agent-Bot, launched alongside the “Action,” provides continuous feedback on operations such as “Provisioning,” “REST,” “REBOOT,” and “APML testing.” It collects status information for the specific action and its historical data over time, feeding this into subsequent stages.

The process evolves through multiple periods, as exemplified by the progression from a reset server state in the first period, through an unknown power state in the second period, to a server stuck in RBSU in the third period. At this point, the “Observe Agent” detects the new state and suggests a new action “(Action): ‘Stop and Check the Boot Menu’.”

The adaptive response leads to a new result “(Result New),” where instead of waiting for two hours, the system stops the task and fails fast. The rapid adjustment demonstrates the ability to dynamically respond to changing server states, minimizing downtime and improving efficiency in the face of unexpected issues. The continuous cycle of observation, action, and result evaluation allows the system to learn and adapt its strategies in real time, enhancing overall performance and reliability in complex server management scenarios.

Observe (States)=Agent({Action, Action' and Historical Actions}, Lookup (Brain)), where the “Observe Agent” collects all “Actions,” new and historical action data. The “Historical Actions” can encompass the full context of the server's state and the actions taken, such as (“Server stuck on RBSU,” “Provisioning Tool, New Action: Stop and Check the Boot Menu”)={Observe(Server is Reboot, Server POWER is unknown, Server stuck on RBSU), Provisioning (Server stuck on RBSU)}.

The comprehensive data collection allows the Agent to maintain a complete picture of the system's evolution over time. Additionally, the Agent performs a crucial step of checking the “Characteristic” against a real-time inference database, represented by the “Lookup (Brain)” function. The lookup process can enable the Agent to leverage previously learned patterns and outcomes, comparing current situations with historical data to make informed decisions.

By combining real-time observations with learned knowledge, the system can adapt its strategies dynamically, improving its ability to handle complex scenarios and unexpected issues in server management and provisioning tasks.

Result or Result New=(Action or Action') and (Historical Results) imply new Action, where the outcome of either the original or the new “Action” is combined with “Historical Results” to determine the next course of action.

For example, “Result (Success)” or “Result New (Stop)=Action(Loading Files)” or “Action'(Powered Off)+(Historical Results).”

The Historical Results provide context, such as “2024-08-29 15:37:15 Boot Sequence to 2024-08-19 17:32:22 Boot to windows”. In this scenario, the Observe function notes that “The server is booted to the operating system for around 1 hour (2024-08-29:16:39:44˜2024-08-29:17:20:15), but the operating system didn't get IP from DHCP.”

Based on the observation and the patterns learned from historical data, the system infers that a “New Action” should be to “Stop” the current process. The decision-making process demonstrates how the system integrates real-time observations with historical patterns to adapt its actions, in this case, recognizing that the failure to obtain an IP address within a reasonable timeframe warrants halting the current operation rather than continuing with potentially futile attempts.

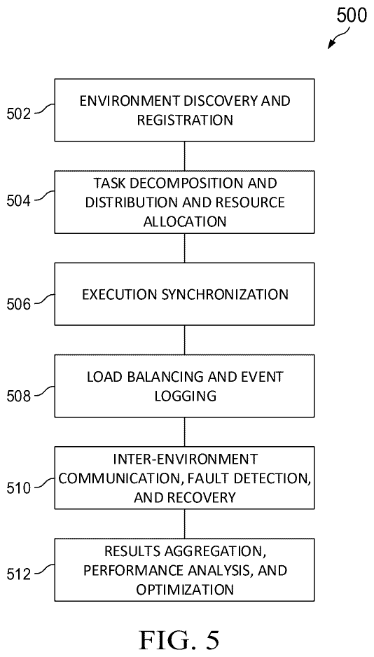

FIG. 5 illustrates a flowchart of an implementation method 500, which may be implemented in system 100 to coordinate simultaneous execution across multiple environments while maintaining a comprehensive log of system activities. It is noted that all steps outlined in the flow chart of method 500 are not necessarily required and can be optional. Further, changes to the arrangement of the steps, removal of one or more steps and path connections, and addition of steps and path connections are similarly contemplated.

At step 502, available servers and test environments within the system's network are identified. Each environment can be registered with a unique identifier, and its capabilities (such as hardware specifications, available software, and network characteristics) can be recorded. The information forms the basis for intelligent distribution and resource allocation.

At step 504, complex testing scenarios are broken down into smaller, manageable units that can be distributed across different environments. The requirements of each task are analyzed and matched with the capabilities of available environments, ensuring optimal workload distribution. A detailed analysis of the computational needs of each distributed task is performed. Resources, such as CPU power, memory, and storage, are allocated across the various environments. In implementations, the allocation is not static but adjustable in real-time based on the changing demands of the tasks and the overall system load.

At step 506, precise timing protocols are established to coordinate the start times and execution phases of distributed tasks to maintain coherence across distributed operations. The synchronization ensures that interdependent tasks are executed in the correct sequence and that time-sensitive operations are performed consistently across all environments.

At step 508, the progress of tasks and the utilization of resources across environments are continuously monitored. If imbalances or bottlenecks are detected, tasks are dynamically redistributed to ensure optimal use of available resources and maintain overall system efficiency. Significant events occurring across the distributed environments are captured and timestamped. This may include task initiations, completions, errors, and any noteworthy system states. The logged data can be stored in a centralized or distributed logging system, providing a comprehensive record for analysis and debugging.

At step 510, the exchange of data and control signals between distributed components is facilitated. The message queues for asynchronous communication are managed, ensuring that information flows smoothly between environments without causing delays or synchronization issues. The system continuously monitors for failures or anomalies in distributed environments. When issues are detected, recovery procedures can be implemented or tasks reassigned to healthy environments, ensuring the continuity of the overall testing process.

At step 512, results from all distributed tasks are collected and consolidated. The data can be synchronized to provide a coherent view of the testing process, enabling comprehensive outcomes analysis across all environments. Execution metrics from the environments are analyzed to identify system-wide patterns, bottlenecks, or inefficiencies. The analysis can inform future task distribution and resource allocation optimizations, continuously improving the system's performance over time.

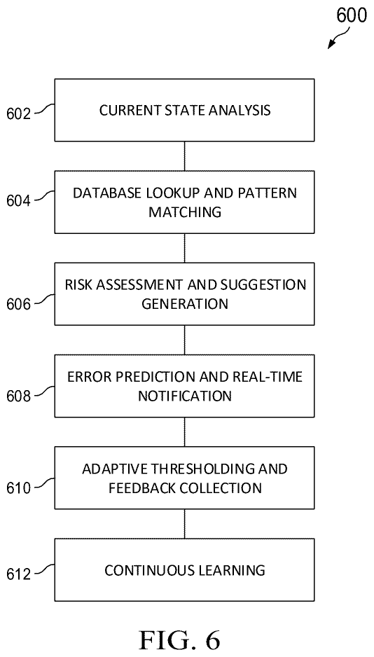

FIG. 6 illustrates a flowchart of an implementation method 600, which may be implemented in system 100 by leveraging the real-time inference database 130 to provide immediate, context-aware feedback and proactive error prevention during software execution and testing. It is noted that all steps outlined in the flow chart of method 600 are not necessarily required and can be optional. Further, changes to the arrangement of the steps, removal of one or more steps and path connections, and addition of steps and path connections are similarly contemplated.

The real-time inference database 130 is configured to memorize the trained data for lookup, fail fast, suggestions, and link to action within a state. The structure efficiently stores and retrieves learned patterns and outcomes, enhancing the system's ability to make informed decisions and predictions.

At step 602, system 100 continuously monitors the current state of the software under test and its execution environment. This can involve aggregating real-time data from various system components, including the environmental data collector circuit 108 and the software launch controller 106. The collected data provides a comprehensive snapshot of the current operational context.

At step 604, system 100 queries the real-time inference database 130 with the current state information. The lookup operation can be designed for high-speed retrieval, utilizing advanced indexing techniques to quickly access relevant historical data and learned patterns that match or closely resemble the current state. The patterns observed in the current state are compared with the historical data retrieved from the real-time inference database 130. Algorithms can be employed to identify similarities and potential deviations, allowing system 100 to recognize familiar scenarios and unusual situations that may require attention.

At step 606, system 100 evaluates potential risks based on the identified patterns. System 100 can calculate the probability of errors or performance issues occurring in the current context by analyzing how similar patterns have led to various outcomes in the past. The assessment can consider factors such as past occurrences'frequency and potential consequences'severity. Actionable suggestions can be formulated based on the risk assessment and pattern analysis. The suggestions can be derived from successful historical outcomes in similar contexts, offering guidance on optimizing performance or avoiding potential issues. System 100 can prioritize the suggestions based on their relevance to the current situation and their potential impact on the software's performance or testing outcomes.

At step 608, current trends are analyzed and compared with known error patterns stored in the real-time inference database 130. This allows system 100 to forecast potential errors before they occur, enabling preemptive action to be taken. The prediction mechanism can consider not only exact matches but also similar patterns that have led to errors in the past, allowing for the detection of novel error scenarios. System 100 can deliver generated suggestions and error predictions to relevant system components or users through predefined communication channels. Each notification can include contextual information and a severity level, allowing recipients to quickly understand the urgency and relevance of the information.

At step 610, system 100 dynamically adjusts its error detection thresholds based on observed system behavior. The adaptive approach allows system 100 to maintain an optimal balance between sensitivity (catching potential issues early) and specificity (avoiding false alarms), adapting to the changing characteristics of the software and its environment over time. Feedback on the effectiveness of the provided suggestions and the accuracy of error predictions can be gathered. The feedback can help assess the system's performance and ensure continuous improvement. System 100 can record the outcomes of actions taken based on its suggestions and the accuracy of its error predictions.

At step 612, the real-time inference database 130 is updated with new outcomes and their contexts. The constant influx of new data allows system 100 to refine its suggestion and error detection algorithms over time. The learning process incorporates both successful and unsuccessful outcomes, enabling system 100 to improve its predictive capabilities and the relevance of its suggestions with each iteration.

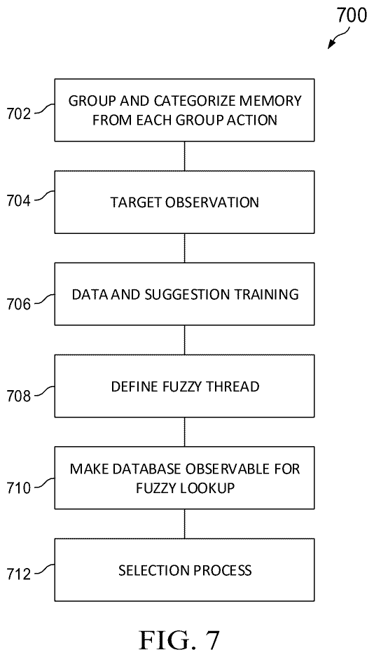

FIG. 7 is a flowchart of an implementation method 700 for data training and learning to continuously improve performance and update the real-time inference database 130. It is noted that all steps outlined in the flow chart of method 700 are not necessarily required and can be optional. Further, changes to the arrangement of the steps, removal of one or more steps and path connections, and addition of steps and path connections are similarly contemplated. The method 700 creates a feedback loop where each new experience enriches the knowledge base, improving performance in future scenarios.

At step 702, system 100 organizes the collected data into meaningful groups based on common characteristics and actions. The process can involve analyzing the incoming data streams from various sources, such as the environmental data collector circuit 108 and the software launch controller 106. System 100 can identify patterns and similarities in the data, creating clusters of related information. The grouping can be based on factors such as the type of software being tested, specific environmental conditions, or particular user actions. System 100 can create a structured framework for more efficient analysis and retrieval in subsequent steps by categorizing the data this way. A “Hit Characteristic” may be determined based on attributes or features that define each group, allowing for quick identification and classification of new incoming data.

At step 704, system 100 verifies to ensure that the stored information matches the observed targets and patterns. This can involve cross-referencing the categorized data from step 702 with real-world outcomes and observations. When a pattern in the real-time inference database 130 is confirmed to be accurate, its Bayesian probability can be adjusted to 1, indicating complete certainty. The adjustment can be advantageous for the system's decision-making process, as it allows system 100 to rely on the confirmed patterns when making predictions or suggestions.

At step 706, system 100 incorporates new data and derived suggestions into the real-time inference database 130, creating a comprehensive and up-to-date knowledge base. Each piece of information can be associated with specific states and actions, allowing for contextual retrieval later. A hash structure can enable fast and efficient storage and retrieval of the information. The training process can involve storing raw data and processing it to extract meaningful insights and suggestions. These suggestions can be linked to the specific conditions (state) and behaviors (actions) under which they are most relevant, creating a rich, interconnected web of knowledge within the real-time inference database 130.

Step 708 introduces flexibility into the system's pattern-matching capabilities. By defining, for example, a fuzzy thread, system 100 establishes a threshold for similarity when looking up actions based on the current state. For example, an 85% TaaS Source indicates the system considers a match valid if the current state is at least 85% similar to a known state in the real-time inference database 130. The fuzzy matching allows the system 100 to make informed decisions even when faced with slightly unfamiliar situations. It balances exact matching (which might be too rigid) and overly loose associations (which might lead to irrelevant actions).

At step 710, with the fuzzy matching criteria established, the real-time inference database 130 can become the reference point for observations and decision-making processes. When the system 100 encounters a new situation, it can consult the real-time inference database 130 using the fuzzy lookup method defined in Step 708.

The approach can allow system 100 to leverage its accumulated knowledge effectively, even in scenarios that don't match previous experiences. Using the real-time inference database 130 as the source for observations, system 100 ensures that its decisions are grounded in historical data and learned patterns while maintaining the flexibility to adapt to new situations.

At step 710, system 100 selects based on, for example, two criteria: the minimum requirements of the current state and the maximum fuzzy thread match. System 100 can identify potential matches in the real-time inference database 130 that meet or exceed the minimum requirements of the current state. From the candidates, it can select the one with the highest fuzzy match score. The dual-criteria approach can ensure that the selected action or suggestion is relevant to the current situation and the best match based on historical data. The TaaS Source Code can implement the selection process, balancing the contextual relevance with the desire to leverage the most similar past experiences.

As a result of this comprehensive process, subsequent observations and decisions made by system 100 can benefit from the continually refined and updated data in the real-time inference database 130. This iterative learning approach enhances the system's ability to make increasingly accurate predictions and provide more relevant suggestions over time.

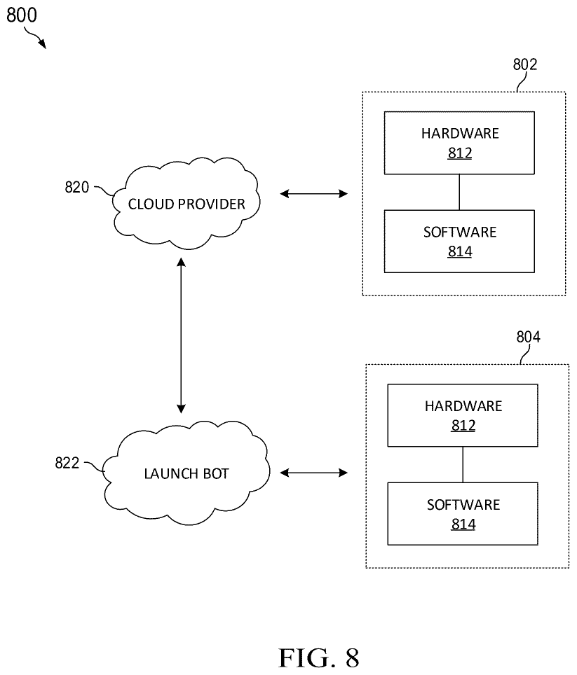

FIG. 8 illustrates a block diagram of an example cloud-based system 800, according to certain implementations. Cloud-based system 800 includes an executing server 802 and a target server 804. Each computing device includes a hardware component 812 and a software environment 814, which may (or may not) be arranged as shown. Cloud-based system 800 may include additional components that are not shown.

In an implementation, the executing server 802 hosts the system 100. System 100 can be implemented as a cloud-based solution maintained and operated by a cloud service provider 820. The cloud-based system 800 offers the advantages of scalability, reliability, and accessibility from virtually anywhere with internet connectivity.

Cloud-based system 800 leverages cloud infrastructure to deliver its functionalities, offering on-demand scalability, ubiquitous access, and managed upkeep. The cloud-based service can reside in a secure, remote data center where resources such as storage, processing power, and networking components are abstracted from the end user and managed by the cloud service provider 820. The cloud-based solution allows for rapid provisioning or de-provisioning of resources to match user demand, which can be accessed over the internet, facilitating seamless interaction from any location.

Executing server 802 provides functions including injecting monitoring and control capabilities into a launch bot 822 comprising software tools or test executables at executing server 802, continuously collecting and analyzing environmental data, recording and organizing observed data in a result and observation memory, maintaining and updating a real-time inference database, and coordinating simultaneous execution across multiple servers and test environments. These functions are implemented through various components such as the software launch controller 106, environmental data collector circuit 108, dynamic update circuit 110, and execution coordinator 112.

In implementations, a user can remotely operate the executing server 802.

This allows personnel, such as IT administrators or operations teams, to manage and observe the target server 804 from disparate locations. This can be particularly beneficial for distributed teams or tasks requiring monitoring outside regular business hours. Users can monitor and configure the target server 804 through remote operation capabilities.

Hardware component 812 is configured to ensure minimal bottlenecks and maximal throughput during the execution of the tasks of the executing server 802 and the target server 804. Hardware component 812 may, for example, be implemented as a computing device. Hardware component 812 may include a multi-core, high-frequency processor, high-speed volatile memory (RAM), solid-state drives (SSD) for rapid data access, and an advanced graphics processing unit (GPU) if the benchmarking involves rendering or computing tasks that benefit from parallel processing. Additionally, cloud-based system 800 may have a robust cooling solution to maintain optimal temperatures under heavy computational loads.

In implementations, software environment 814 includes an operating system, typically configured for maximum performance. Software environment 814 may include drivers and libraries updated to the latest versions to ensure compatibility and performance optimization for the hardware component 812.

Additionally, software environment 814 may include specialized software components such as the real-time inference database 130, observation memory database 132, and other tools for implementing the interactive software launching and testing functionalities.

The cloud-based system 800 enables efficient data exchange between the executing server 802 and target server 804. The setup allows for real-time monitoring, analysis, and adjustment of software execution on the target server 804. The cloud infrastructure facilitates storing and processing large volumes of environmental data and execution results, enabling more comprehensive analysis and improved decision-making capabilities.

The cloud-based implementation also enhances the system's ability to scale and adapt to varying workloads. It can dynamically allocate resources to handle peak testing periods or complex scenarios that require additional computational power. This elasticity ensures the system can maintain optimal performance even under demanding conditions.

Further, the cloud-based architecture supports seamless updates and improvements to the system's components, such as the real-time inference database and analysis algorithms. This allows for continuous refinement of the system's predictive and adaptive capabilities without disrupting ongoing testing processes.

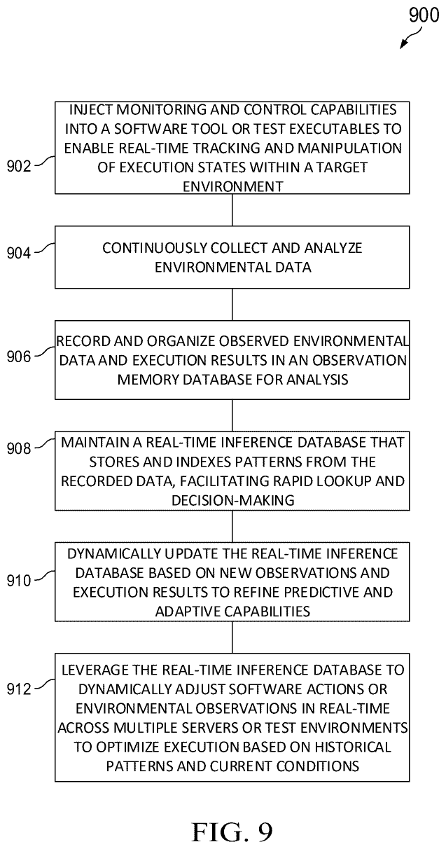

FIG. 9 illustrates a flowchart of an implementation method 900, which may be implemented in system 100. Method 900 is an interactive software launching and testing method. It is noted that all steps outlined in the flow chart of method 900 are not necessarily required and can be optional. Further, changes to the arrangement of the steps, removal of one or more steps and path connections, and addition of steps and path connections are similarly contemplated.

At step 902, monitoring and control capabilities are injected into the software tool or test executables to enable real-time tracking and manipulation of execution states within the target environment.

Once this foundation is laid, at step 904, a continuous cycle of data collection and analysis is performed, where environmental data is constantly gathered and examined in real-time.

At step 906, as the system collects data, it simultaneously records and organizes the observed environmental data and execution results in an observation memory database. The organized storage facilitates efficient retrieval and analysis.

At step 908, a real-time inference database is maintained, which stores and indexes patterns derived from the recorded data. The database is designed for rapid lookup and decision-making, serving as the system's knowledge repository.

In an implementation, a fuzzy matching mechanism establishes a threshold for similarity when looking up actions based on the current state.

In an implementation, machine learning algorithms are employed to enhance the predictive capabilities of the real-time inference database.

In an implementation, a data retention policy is implemented to optimize storage utilization and maintain system performance by defining how long different types of data are kept in active memory.

In an implementation, a data compression mechanism is used to maximize storage efficiency of the real-time inference database.

In an implementation, an error-checking and data integrity system is used to ensure the reliability and accuracy of stored information in the real-time inference database.

In an implementation, error detection thresholds are dynamically adjusted based on observed system behavior to maintain an optimal balance between sensitivity and specificity.

At step 910, the real-time inference database undergoes continuous refinement through a dynamic updating process. New observations and execution results are consistently incorporated, enhancing the database's predictive and adaptive capabilities. This ever-evolving knowledge base is then leveraged to make real-time adjustments to software actions or environmental observations across multiple servers or test environments.

At step 912, in each cycle, the software actions or environmental observations are dynamically adjusted based on the insights gleaned from the real-time inference database. The adjustments aim to optimize execution by considering both historical patterns and current conditions across the various environments. This process continues in a loop, constantly collecting new data, updating the database, and making informed adjustments until the testing or execution is complete. Through this iterative approach, the method ensures continuous improvement and adaptation in software launching and testing processes.

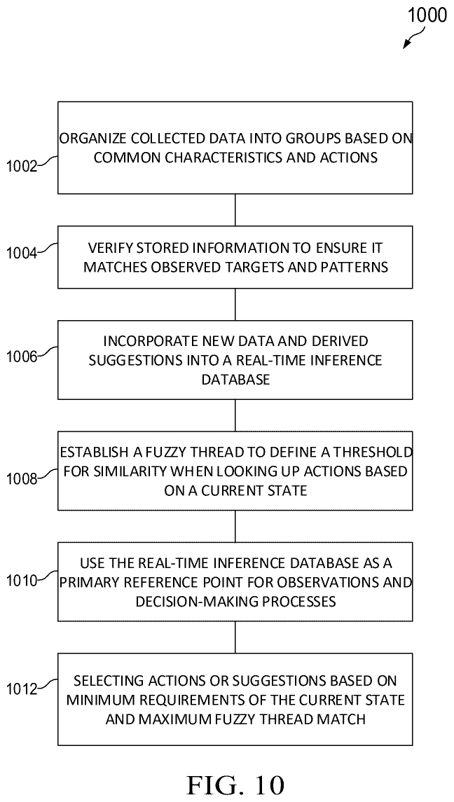

FIG. 10 illustrates a flowchart of an implementation method 1000, which may be implemented in system 100. Method 1000 is an interactive software launching and testing method. It is noted that all steps outlined in the flow chart of method 1000 are not necessarily required and can be optional. Further, changes to the arrangement of the steps, removal of one or more steps and path connections, and addition of steps and path connections are similarly contemplated.

At step 1002, collected data are organized into groups. This initial step involves categorizing data based on common characteristics and actions, creating a structured foundation for analysis.

At step 1004, stored information is cross-checked against observed targets and patterns, ensuring the accuracy and relevance of the data.

At step 1006, new data and derived suggestions are incorporated into a real-time inference database to maintain an up-to-date and comprehensive knowledge base.

At step 1008, a fuzzy thread is established, which defines a threshold for similarity when looking up actions based on the current state. The fuzzy matching approach allows for flexibility in decision-making, accommodating scenarios that may not match previous experiences.

At step 1010, the real-time inference database is the reference point for observations and decision-making processes. This ensures that all decisions are grounded in the accumulated knowledge and patterns stored in the database.

In an implementation, Bayesian probabilities are adjusted to 1 for patterns in the real-time inference database confirmed to be accurate.

In an implementation, a hash structure is employed for fast and efficient storage and retrieval of information in the real-time inference database.

In an implementation, raw data are processed to extract meaningful insights and suggestions and the suggestions are linked to specific conditions and behaviors.

At step 1012, actions or suggestions are selected based on, for example, two criteria: the minimum requirements of the current state and the maximum fuzzy thread match. This dual-criteria approach ensures that the chosen action or suggestion is relevant to the current situation and the best match based on historical data.

This flowchart represents a continuous learning cycle where the system constantly refines its knowledge base and decision-making capabilities. By organizing, verifying, incorporating, and leveraging data in this structured manner, the interactive software launching and testing system can adapt and improve its performance over time, making increasingly accurate and relevant decisions based on current conditions and historical patterns.

Although this disclosure describes or illustrates particular operations as occurring in a particular order, this disclosure contemplates the operations occurring in any suitable order. Moreover, this disclosure contemplates any suitable operations being repeated one or more times in any suitable order. Although this disclosure describes or illustrates particular operations as occurring in sequence, this disclosure contemplates any suitable operations occurring at substantially the same time, where appropriate. Where appropriate, any suitable operation or sequence described or illustrated herein may be interrupted, suspended, or otherwise controlled by another process, such as an operating system or kernel. The acts can operate in an operating system environment or as stand-alone routines occupying all or a substantial part of the system processing.

While this disclosure has been described with reference to illustrative implementations, this description is not intended to be construed in a limiting sense.

Various modifications and combinations of the illustrative implementations, as well as other implementations of the disclosure, will be apparent to persons skilled in the art upon reference to the description. Therefore, the appended claims are intended to encompass any such modifications or implementations.

What is claimed is:

1. A computer system for interactive software launching and testing, the computer system comprising:
a processor; and
a non-transitory memory storing instructions that, when executed by the processor, cause the computer system to:
inject monitoring and control capabilities into a software tool or test executables to enable real-time tracking and manipulation of execution states within a target environment,
continuously collect and analyze environmental data,
record and organize observed environmental data and execution results in a result and observation memory for analysis,
employ a real-time inference database for storing and indexing patterns from the recorded data, facilitating rapid lookup and decision-making,
dynamically update the real-time inference database based on new observations and execution results to refine predictive and adaptive capabilities, and
leverage the real-time inference database to coordinate a simultaneous execution of software actions or environmental observations across multiple servers and test environments.

2. The computer system of claim 1, wherein the computer system provides real-time execution adjustments and error detection based on rapid lookups in the real-time inference database during software execution and testing.

3. The computer system of claim 1, wherein the environmental data comprises hardware configurations, network conditions, system loads influencing execution results, or a combination thereof.

4. The computer system of claim 1, wherein coordinating simultaneous execution of software actions and environmental observations across multiple servers and test environments comprises:
synchronizing execution timings across multiple servers and test environments;
dynamically allocating computational resources based on real-time demand;
maintaining a distributed event log to track actions and observations across the multiple servers and test environments;
implementing a load balancing mechanism to optimize resource utilization; and
providing inter-environment communication channels to share critical information in real-time between the multiple servers and test environments.

5. The computer system of claim 1, wherein the instructions further cause the computer system to employ a pruning mechanism to manage data growth in the real-time inference database by identifying and removing outdated or irrelevant information.

6. The computer system of claim 1, wherein the instructions further cause the computer system to implement a hierarchical structure in the real-time inference database, organizing data at different granularity levels to efficiently narrow relevant data.

7. The computer system of claim 1, wherein the instructions further cause the computer system to implement a confidence scoring system for each decision or prediction based on factors including an amount of relevant historical data, consistency of past outcomes, similarity of current scenarios to previously encountered situations, or a combination thereof.

8. A computer-implemented method for interactive software launching and testing, the computer-implemented method comprising:
injecting monitoring and control capabilities into a software tool or test executables to enable real-time tracking and manipulation of execution states within a target environment;
continuously collecting and analyzing environmental data;
recording and organizing observed environmental data and execution results in a result and observation memory for analysis;
maintaining an real-time inference database that stores and indexes patterns from the recorded data, facilitating rapid lookup and decision-making;
dynamically updating the real-time inference database based on new observations and execution results to refine predictive and adaptive capabilities; and
leveraging the real-time inference database to dynamically adjust software actions or environmental observations in real-time across multiple servers or test environments to optimize execution based on historical patterns and current conditions.

9. The computer-implemented method of claim 8, further comprising implementing a fuzzy matching mechanism to establish a threshold for similarity when looking up actions based on the current state.

10. The computer-implemented method of claim 8, further comprising employing machine learning algorithms to enhance predictive capabilities of the real-time inference database.

11. The computer-implemented method of claim 8, further comprising implementing a data retention policy to optimize storage utilization and maintain system performance by defining how long different types of data are kept in active memory.

12. The computer-implemented method of claim 8, further comprising implementing a data compression mechanism to maximize storage efficiency of the real-time inference database.

13. The computer-implemented method of claim 8, further comprising implementing an error-checking and data integrity system to ensure reliability and accuracy of stored information in the real-time inference database.

14. The computer-implemented method of claim 8, further comprising dynamically adjusting error detection thresholds based on observed system behavior to maintain an optimal balance between sensitivity and specificity.

15. A computer-implemented method for training and learning in an interactive software launching and testing system, the method comprising:
organizing collected data into groups based on common characteristics and actions;
verifying stored information to ensure it matches observed targets and patterns;
incorporating new data and derived suggestions into a real-time inference database;
establishing a fuzzy thread to define a threshold for similarity when looking up actions based on a current state;
using the real-time inference database as a reference point for observations and decision-making processes; and
selecting actions or suggestions based on minimum requirements of the current state and maximum fuzzy thread match.

16. The computer-implemented method of claim 15, further comprising adjusting Bayesian probabilities to 1 for patterns in the real-time inference database confirmed to be accurate.

17. The computer-implemented method of claim 15, further comprising using a hash structure for fast and efficient storage and retrieval of information in the real-time inference database.

18. The computer-implemented method of claim 15, further comprising processing raw data to extract meaningful insights and suggestions, and linking these suggestions to specific conditions and behaviors.

19. The computer-implemented method of claim 15, further comprising implementing a dual-criteria approach for action selection that ensures relevance to a current configuration and best match based on historical data.

20. The computer-implemented method of claim 15, further comprising continuously refining and updating data in the real-time inference database to enhance the system's ability to make increasingly accurate predictions and provide more relevant suggestions over time.
